(19) United States
(12) Patent Application Publication
(10) Pub. No.: US 2012/0268343 A1
(43) Pub. Date: Oct. 25, 2012

(54) ANTENNA APPARATUS

(75) Inventors: Masahiro Yanagi, Tokyo (JP); Shigemi Kurashima, Tokyo (JP); Hideaki Yoda, Tokyo (JP)

(73) Assignee: FUJITSU COMPONENT LIMITED, Tokyo (JP)

(21) Appl. No.: 13/444,915

(22) Filed: Apr. 12, 2012

(30) Foreign Application Priority Data
Apr. 25, 2011 (JP) 2011-097608

(51) Int. Cl. H01Q 1/42

(52) U.S. Cl. 343/872

(57) ABSTRACT

An antenna apparatus includes a housing made of a conductive material and having a slot formed in a first surface, and an antenna disposed in the housing. The longitudinal direction of the slot is oriented at a predetermined angle with respect to the longitudinal direction of the antenna.

### CROSS-REFERENCE TO RELATED APPLICATION

This application is based upon and claims the benefit of priority of Japanese Patent Application No. 2011-097608 filed on Apr. 25, 2011, the entire contents of which are incorporated herein by reference.

### FIELD

The embodiments discussed herein are related to an antenna apparatus.

### BACKGROUND

Japanese Laid-Open Patent Publication No. 2004-242034, for example, discloses an antenna apparatus including a metal housing having a slot and a radio device disposed in the metal housing. The slot is supplied with power via electromagnetic waves emitted from the radio device.

In such a related-art antenna apparatus, the plane of polarization of electromagnetic waves emitted from the radio device is adjusted by the slot of the metal housing.

With this configuration, since the gain of radio waves emitted from the slot is low, the antenna efficiency tends to be low.

### SUMMARY

According to an aspect of this disclosure, there is provided an antenna apparatus that includes a housing made of a conductive material and having a slot formed in a first surface, and an antenna disposed in the housing. The longitudinal direction of the slot is oriented at a predetermined angle with respect to the longitudinal direction of the antenna.

The object and advantages of the invention will be realized and attained by means of the elements and combinations particularly pointed out in the claims.

It is to be understood that both the foregoing general description and the followed detailed description are exemplary and explanatory and are not restrictive of the invention as claimed.

### BRIEF DESCRIPTION OF DRAWINGS

FIGS. 1A and 1B are drawings illustrating an antenna apparatus of a first comparative example;

FIGS. 2A through 2C are drawings illustrating characteristics of the antenna apparatus of the first comparative example;

FIG. 3 is a drawing illustrating an antenna apparatus of a second comparative example;

FIG. 4 is a drawing illustrating an antenna apparatus of a first embodiment;

FIGS. 5A through 5C are drawings illustrating characteristics of the antenna apparatus of the first embodiment;

FIGS. 6A and 6B are drawings illustrating another antenna apparatus of the first embodiment;

FIG. 7 is a drawing illustrating an antenna apparatus of a second embodiment;

FIGS. 8A through 8C are drawings illustrating characteristics of the antenna apparatus of the second embodiment;

FIG. 9 is a drawing illustrating a variation of the antenna apparatus of the second embodiment;

FIGS. 10A through 10C are drawings illustrating characteristics of the variation of the antenna apparatus of the second embodiment;

FIG. 11 is a drawing illustrating an antenna apparatus of a third embodiment;

FIGS. 12A through 12C are drawings illustrating characteristics of the antenna apparatus of the third embodiment;

FIG. 13 is a drawing illustrating an antenna apparatus according to a first variation of the third embodiment;

FIG. 14 is a drawing illustrating an antenna apparatus according to a second variation of the third embodiment;

FIG. 15 is a drawing illustrating an antenna apparatus of a third comparative example;

FIGS. 16A and 16B are drawings illustrating characteristics of the antenna apparatus of the third comparative example;

FIG. 17 is a drawing illustrating an antenna apparatus of a fourth embodiment; and

FIGS. 18A and 18B are drawings illustrating characteristics of the antenna apparatus of the fourth embodiment.

### DESCRIPTION OF EMBODIMENTS

Preferred embodiments of the present invention are described below with reference to the accompanying drawings.

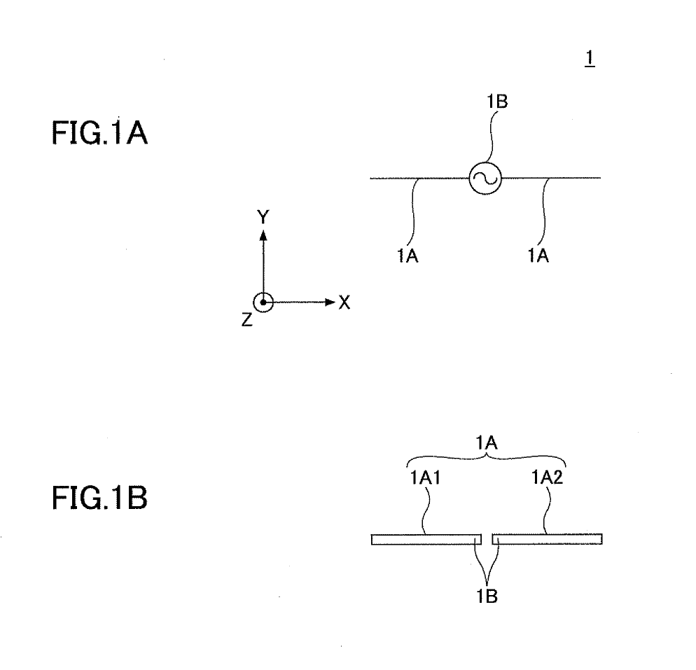

Before describing antenna apparatuses of present embodiments, antenna apparatuses of first and second comparative examples are described with reference to FIGS. 1A through FIG. 3.

### First Comparative Example

FIGS. 1A and 1B are drawings illustrating an antenna apparatus 1 of the first comparative example.

The antenna apparatus 1 includes a dipole antenna 1A and a feeder 1B. In FIG. 1A, the feeder 1B is represented by a symbol at the center of the dipole antenna 1A. In an actual configuration, as illustrated in FIG. 1B, the dipole antenna 1B includes two elements 1A1 and 1A2 and the feeder 1B is provided between them. More specifically, a feed point 1B is provided at an end of each of the elements 1A1 and 1A2. Power is supplied to the feed points 1B via, for example, microstrip lines or coaxial cables. For brevity, in the drawings of the present application, a dipole antenna is represented by a symbol like that in FIG. 1A.

The length of the dipole antenna 1A is, for example, set at one half of the wavelength of an operating frequency (a frequency being used by the antenna apparatus 1). The length of the dipole antenna 1A is the sum of the lengths of the elements 1A1 and 1A2. For example, when the operating frequency is 2.45 GHz, the length of the dipole antenna 1A is about 60 mm, and the length of each of the elements 1A1 and 1A2 is 30 mm.

The dipole antenna 1A is implemented, for example, by forming a pattern of copper foil on a substrate made of an insulator (dielectric material).

The feeder 1B is provided at the center in the length direction of the dipole antenna 1A. Electric power with the operating frequency is supplied from a communication device (not shown) to the feeder 1B of the antenna apparatus 1.

In FIG. 1A, X, Y, and Z indicate axes that are orthogonal to each other in a three-dimensional space. The dipole antenna 1A extends in the X-axis direction.

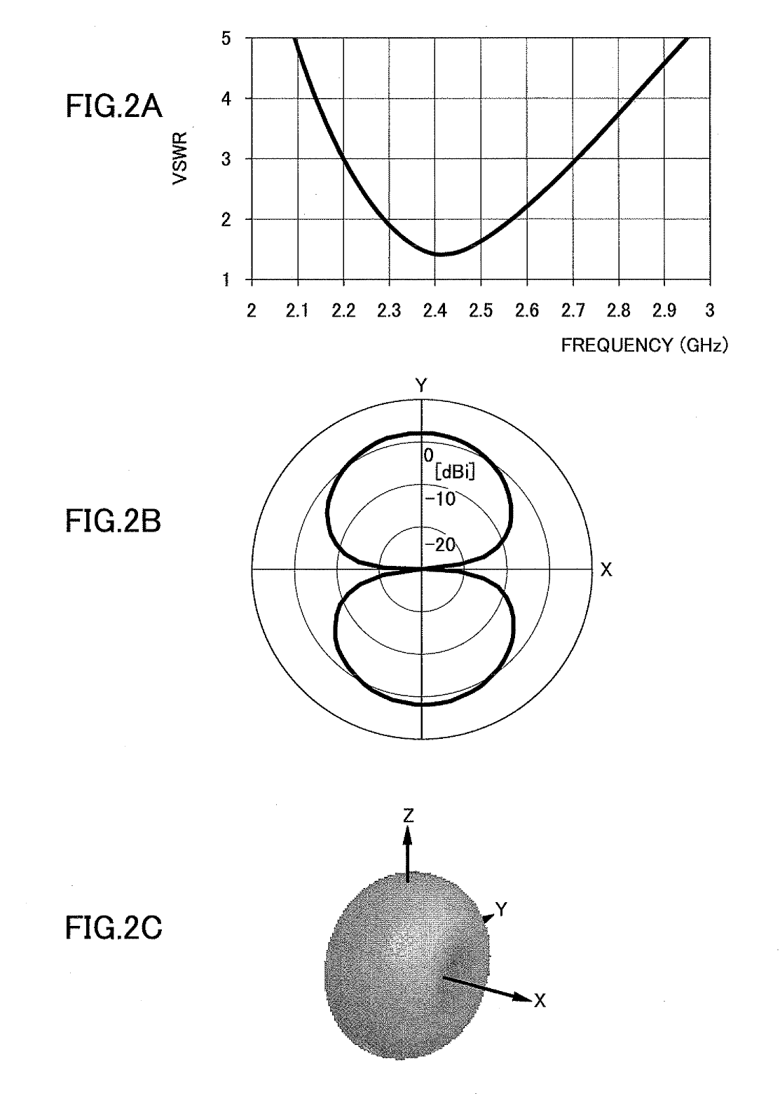

FIGS. 2A through 2C are drawings illustrating characteristics of the antenna apparatus 1 of the first comparative example. FIG. 2A illustrates frequency characteristics of the voltage standing wave ratio (VSWR). FIG. 2B illustrates directivity on the XY plane. FIG. 2C illustrates directivity represented by the sum of vertical polarization, horizontal polarization, and circular polarization. These antenna characteristics were obtained through a simulation where the operating frequency of the antenna apparatus 1 was set at 2.45 GHz.

As illustrated in FIG. 2A, the antenna apparatus 1 exhibits the lowest VSWR of about 1.5 at the operating frequency of 2.45 GHz. A VSWR of 1.5 is a good value that indicates a small amount of reflection.

As illustrated in FIG. 2B, the directivity of the antenna apparatus 1 on the XY plane is symmetrical with respect to the X axis. Also, as illustrated in FIG. 2C, the directivity of the antenna apparatus 1 represented by the sum of vertical polarization, horizontal polarization, and circular polarization is symmetrical with respect to the X axis.

### Second Comparative Example

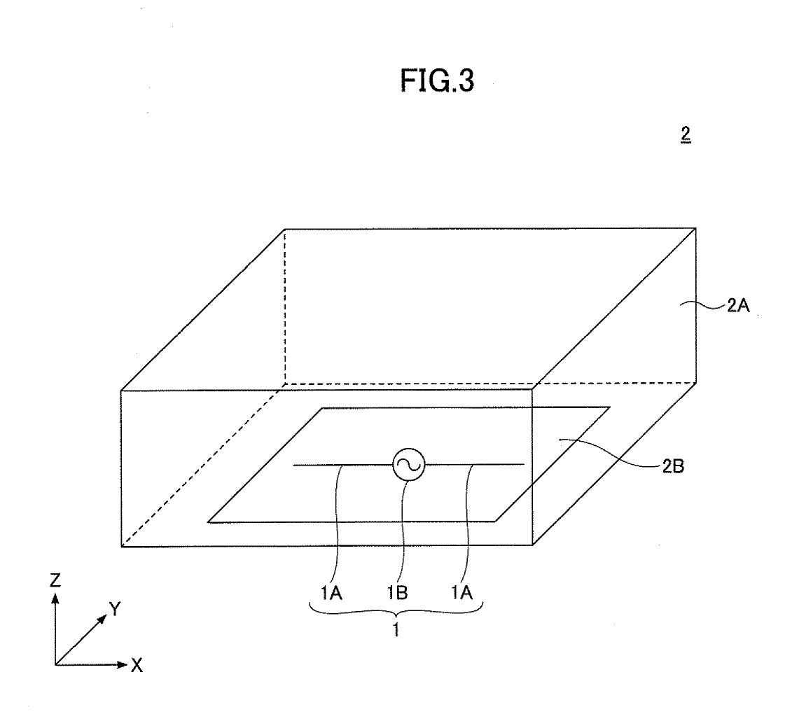

Next, an antenna apparatus 2 of the second comparative example is described with reference to FIG. 3.

FIG. 3 is a drawing illustrating the antenna apparatus of the second comparative example.

The antenna apparatus 2 includes the dipole antenna 1A, the feeder 1B, a metal housing 2A, and a substrate 2B. Thus, the antenna apparatus 2 includes the antenna apparatus 1 of the first comparative example which is disposed in the housing 2A.

For example, the housing 2A may be made of aluminum and have a cuboid shape whose six sides are closed. The substrate 2B may be made of an insulator (dielectric material) and disposed on the inner bottom surface of the housing 2A. Transmission waves may be supplied from a power supply in the housing 2A via a communication device to the feeder 1B.

The antenna apparatus 1 is formed on the substrate 2B. In FIG. 3, for illustration purposes, the dipole antenna 1A, the feeder 1B, and the substrate 2B are seen through the housing 2A.

With the configuration of FIG. 3, since the dipole antenna 1A is enclosed in the housing 2A, radio waves emitted from the dipole antenna 1A are blocked by the housing 2A and do not exit the housing 2A.

Next, antenna apparatuses according to embodiments of the present invention are described.

### First Embodiment

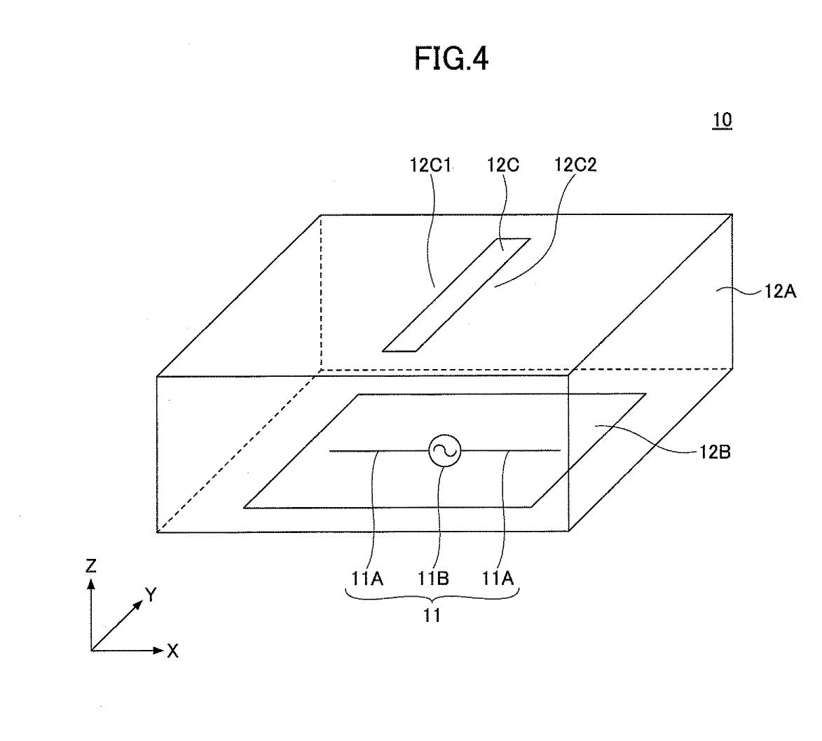

FIG. 4 is a drawing illustrating an antenna apparatus 10 of a first embodiment.

The antenna apparatus 10 may include a dipole antenna 11A and a feeder 11B, a housing 12A, and a substrate 12B. The dipole antenna 11A and the feeder 11B may be collectively called an antenna 11.

In FIG. 4, X, Y, and Z indicate axes that are orthogonal to each other in a three-dimensional space. The dipole antenna 11A extends in the X-axis direction.

The substrate 12B may be made of an insulator (dielectric material) and disposed on the inner bottom surface of the housing 12A. The dipole antenna 11A is disposed on the substrate 12B. For example, the dipole antenna 11A may be formed by patterning copper foil.

The length of the dipole antenna 11A is, for example, set at one half of the wavelength of an operating frequency (a frequency being used by the antenna apparatus 10). For example, when the operating frequency is 2.45 GHz, the length of the dipole antenna 11A is about 60 mm. Similarly to the dipole antenna 1A of the first comparative example (see FIG. 1B), the dipole antenna 11A may include two elements, and the length of the dipole antenna 11A may be represented by the sum of the lengths of the elements.

The feeder 11B is provided at the center in the length direction of the dipole antenna 11A. Electric power with the operating frequency is supplied from a communication device (not shown) to the feeder 11B of the antenna apparatus 10.

The housing 12A may have a cuboid shape and may be made of a conductive material such as a metal. Preferably, the housing 12A includes aluminum. A slot 12C is formed in the upper surface (upper face or upper wall) of the housing 12A.

The longitudinal direction (direction of the longer side) of the slot 12C is oriented along the Y axis, and the lateral direction (direction of the shorter side) of the slot 12C is oriented along the X axis. The longitudinal direction of the slot 12C is oriented at a predetermined angle with respect to the longitudinal direction of the dipole antenna 11A. In this example, the longitudinal direction (Y-axis direction) of the slot 12C is orthogonal to (i.e., at 90 degrees with) the longitudinal direction (X-axis direction) of the dipole antenna 11A.

The length in the longitudinal direction of the slot 12C is one half (λ/2) of the wavelength (λ) of the operating frequency of the antenna apparatus 10.

Transmission waves may be supplied from a power supply in the housing 12A via a communication device to the feeder 11B.

The housing 12A has no opening other than the slot 12C.

In FIG. 4, for illustration purposes, the dipole antenna 11A, the feeder 11B, and the substrate 12B are seen through the housing 12A.

With the antenna apparatus 10 configured as described above, when transmission waves are supplied to the feeder 11B, the dipole antenna 11A emits radio waves. The radio waves emitted from the dipole antenna 11A in the −Z direction are blocked by the bottom surface (bottom side or bottom wall) of the housing 12A.

With this configuration, the directivity of the dipole antenna 11A in the housing 12A is represented by an upper half of the directivity distribution of the dipole antenna 1A of the antenna apparatus 1 which is illustrated in FIG. 2C (i.e., the +Z side of the directivity distribution above the XY plane).

Meanwhile, since the slot 120 is formed in the housing 12A enclosing the dipole antenna 11A, the radio waves emitted from the dipole antenna 11A exit the housing 12A via the slot 12C.

Here, the direction of an electric field formed by the dipole antenna 11A is oriented along the X axis, and the lateral direction of the slot 120 is oriented along the X axis.

Accordingly, an electric field is generated between a first side 1201 and a second side 1202 that face each other across the slot 12C in the lateral direction (X-axis direction). Therefore, the slot 12C provides substantially the same function as the dipole antenna 11A extending in the X-axis direction. Since the length in the longitudinal direction of the slot 12C is set at λ/2, the slot 12C resonates with radio waves emitted from the dipole antenna 11A and as a result, polarized electromagnetic radiation in the X-axis direction is emitted.

Thus, with the antenna apparatus 10 of the first embodiment, radio waves are emitted from the slot 12C when radio waves are emitted by the dipole antenna 11A.

Since the housing 12A has no opening other than the slot 12C, radio waves are emitted only from the slot 12C.

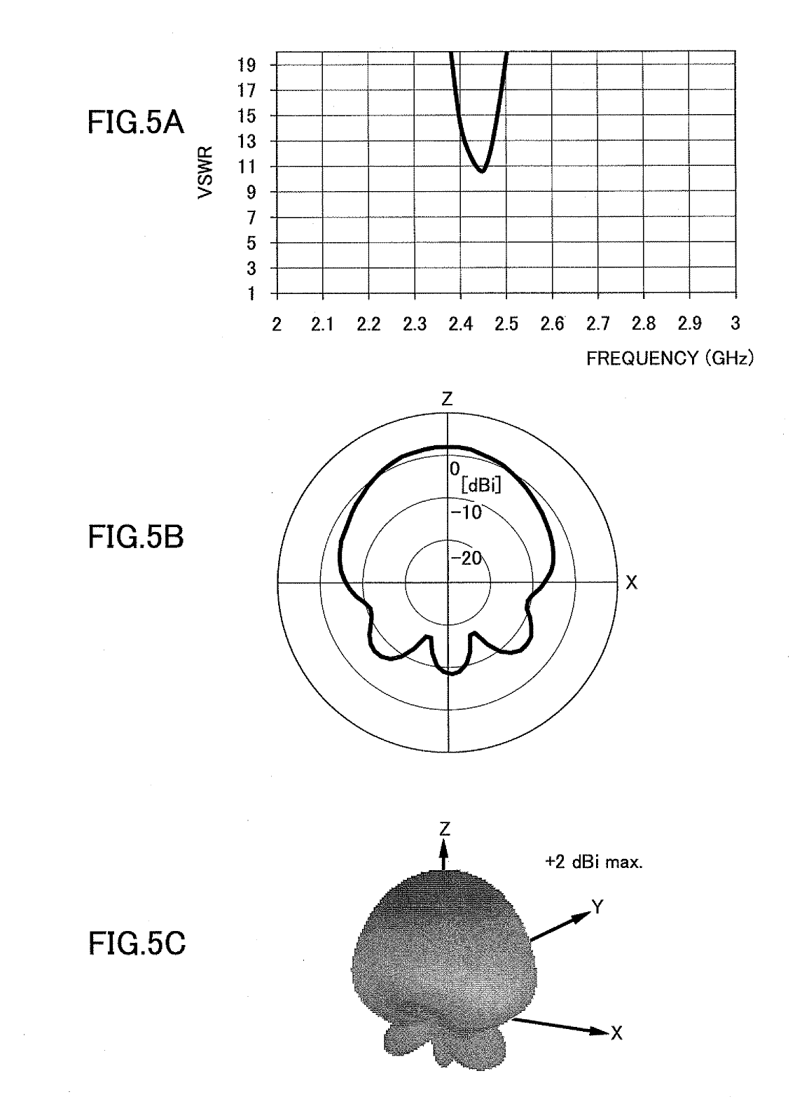

FIGS. 5A through 5C are drawings illustrating characteristics of the antenna apparatus 10 of the first embodiment. FIG. 5A illustrates frequency characteristics of the voltage standing wave ratio (VSWR). FIG. 5B illustrates directivity on the XZ plane. FIG. 5C illustrates directivity represented by the sum of vertical polarization, horizontal polarization, and circular polarization. These antenna characteristics were obtained through a simulation where the operating frequency of the antenna apparatus 10 was set at 2.45 GHz.

As illustrated in FIG. 5A, the antenna apparatus 10 exhibits the lowest VSWR (about 10) at the operating frequency of 2.45 GHz.

As illustrated in FIG. 5B, the directivity of the antenna apparatus 10 in the +Z direction on the XZ plane is around 0 (dBi) and substantially uniform. This result indicates that radio waves are emitted in the +Z direction via the slot 12C.

As illustrated in FIG. 5C, the distribution of the directivity of the antenna apparatus 10 represented by the sum of vertical polarization, horizontal polarization, and circular polarization extends in the +Z direction, and is wider in the X-axis direction than in the Y-axis direction. The highest value of the directivity represented by the sum of vertical polarization, horizontal polarization, and circular polarization is +2 dBi.

As described above, with the antenna apparatus 10 of the first embodiment, it is possible to determine the directivity by the slot 12C whose longitudinal direction is orthogonal to the longitudinal direction of the dipole antenna 11A. This configuration also makes it possible to increase the gain of radio waves emitted from a slot and to improve the antenna efficiency.

Accordingly, the above configuration makes it possible to efficiently emit radio waves in a desired direction, depending on the purpose, by adjusting the orientation of the slot 12C.

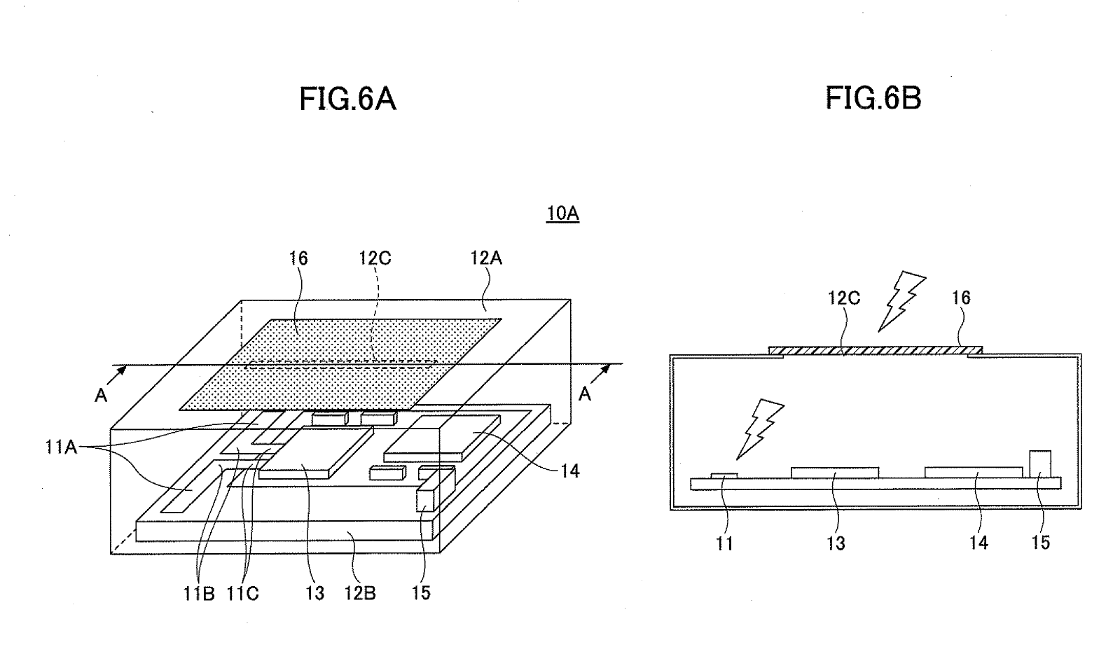

Next, an antenna apparatus 10A according to the first embodiment is described with reference to FIG. 6.

FIGS. 6A and 6B are drawings illustrating the antenna apparatus 10A of the first embodiment. FIG. 6A is a perspective view of the antenna apparatus 10A. In FIG. 6A, for illustration purposes, inner components of the antenna apparatus 10A are seen through its housing. FIG. 6B is a cross-sectional view of FIG. 6A taken along line A-A.

The antenna apparatus 10A is a more practical implementation of the antenna apparatus 10 of FIG. 4 and may be produced by adding circuits (e.g., a communication circuit) to the antenna apparatus 10.

The antenna apparatus 10A may include the dipole antenna 11A, the feeder 11B, the housing 12A, the substrate 12B, a radio frequency (RF) module 13, a micro control unit (MCU) 14, a power supply 15, and a cover 16.

The RF module 13 is connected to the feeder 11B via a microstrip line 11C. The RF module 13 is also connected via wiring on the substrate 12B to the MCU 14 and the power supply 15.

The RF module 13 is supplied with power from the power supply 15 and controlled by the MCU 14, and causes the dipole antenna 11A to emit radio waves.

The MCU 14 is supplied with power from the power supply 15, and controls the RF module 13 to cause the dipole antenna 11A to emit radio waves.

The power supply 15 may be implemented by, for example, a rechargeable secondary battery.

The cover 16 is disposed on the upper surface of the housing 12A so as to cover a slot 12C formed in the upper surface of the housing 12A. The cover 16 may be made of any insulating material that can cover the slot 12C. For example, the cover 16 may be made of a resin, glass, or fabric.

When the housing 12A and the cover 16 are prepared to have a sufficient strength, the antenna apparatus 10A may be used, for example, for a smart meter.

A smart meter, for example, measures power consumption and transmits a signal indicating the measured power consumption to a remote site. The antenna apparatus 10A of the first embodiment may be used as a remote monitoring device such as a smart meter by adding a power meter. The antenna apparatus 10A may be made durable for long-term outdoor use by using the housing 12A and the cover 16 having a sufficient strength.

### Second Embodiment

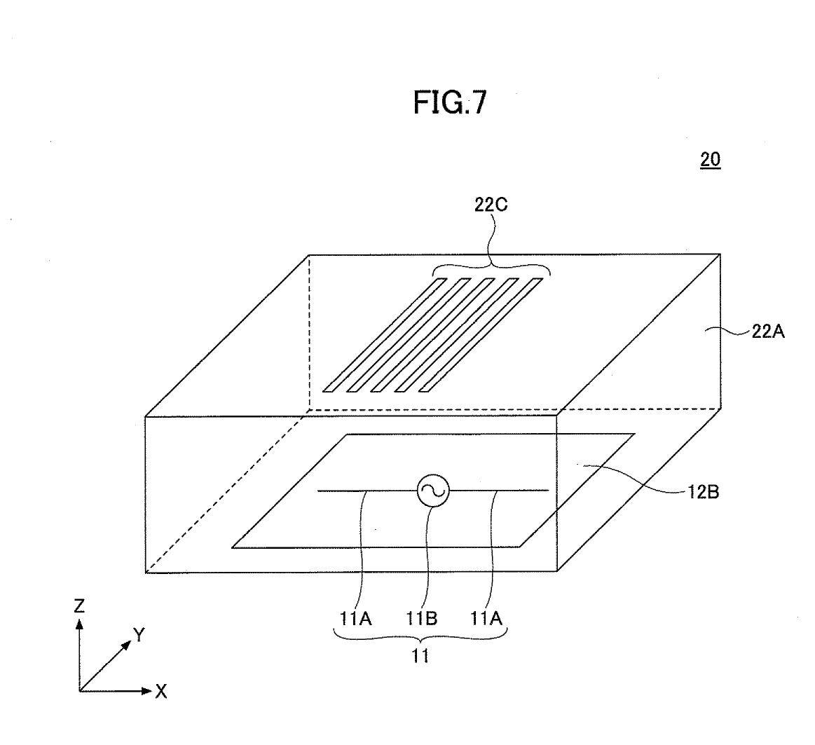

FIG. 7 is a drawing illustrating an antenna apparatus 20 of a second embodiment.

The antenna apparatus 20 of the second embodiment is different from the antenna apparatus 10 of the first embodiment (see FIG. 4) in that five slots 22C are formed in the upper surface of a housing 22A. Other components of the antenna apparatus 20 are substantially the same as those of the antenna apparatus 10 of the first embodiment. Therefore, the same reference numbers are assigned to those components and their descriptions are omitted here. In FIG. 7, for illustration purposes, the dipole antenna 11A, the feeder 11B, and the substrate 12B are seen through the housing 22A.

The housing 22A may have a cuboid shape and may be made of a conductive material such as a metal. Preferably, the housing 22A includes aluminum. Five slots 22C are formed in the upper surface (upper face or upper wall) of the housing 22A. The length in the longitudinal direction of each of the slots 22C is one half (λ/2) of the wavelength (λ) of the operating frequency of the antenna apparatus 20.

Similarly to the slot 12C of the antenna apparatus 10 of the first embodiment, the longitudinal direction (direction of the longer sides) of the slots 22C is oriented along the Y axis, and the lateral direction (direction of the shorter sides) of the slots 22C is oriented along the X axis. The longitudinal direction of the slot 22C is oriented at a predetermined angle with respect to the longitudinal direction of the dipole antenna 11A. In this example, the longitudinal direction (Y-axis direction) of the slots 22C is orthogonal to the longitudinal direction (X-axis direction) of the dipole antenna 11A.

The antenna apparatus 20 of the second embodiment emits radio waves in the +Z direction from the five slots 22C.

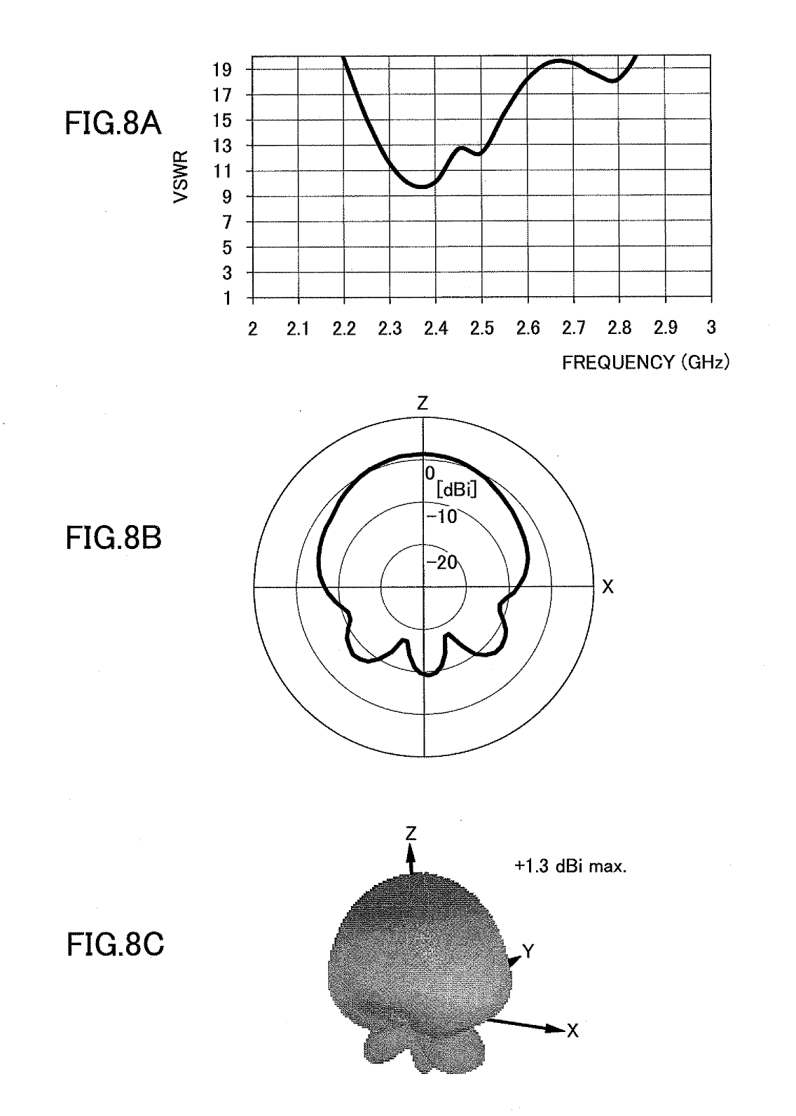

FIGS. 8A through 8C are drawings illustrating characteristics of the antenna apparatus 20 of the second embodiment. FIG. 8A illustrates frequency characteristics of the voltage standing wave ratio (VSWR). FIG. 8B illustrates directivity on the XZ plane. FIG. 8C illustrates directivity represented by the sum of vertical polarization, horizontal polarization, and circular polarization. These antenna characteristics were obtained through a simulation where the operating frequency of the antenna apparatus 20 was set at 2.45 GHz.

As illustrated in FIG. 8A, the antenna apparatus 20 exhibits the lowest VSWR (about 10) at the operating frequency of 2.45 GHz. Compared with the antenna apparatus 10 of the first embodiment, the antenna apparatus 20 has wider VSWR characteristics.

As illustrated in FIG. 8B, the directivity of the antenna apparatus 20 in the +Z direction on the XZ plane is around 0 (dBi) and substantially uniform. This result indicates that radio waves are emitted in the +Z direction via the slots 22C.

As illustrated in FIG. 8C, the distribution of the directivity of the antenna apparatus 20 represented by the sum of vertical polarization, horizontal polarization, and circular polarization extends in the +Z direction, and is wider in the X-axis direction than in the Y-axis direction. The highest value of the directivity represented by the sum of vertical polarization, horizontal polarization, and circular polarization is +1.3 dBi.

Similarly to the antenna apparatus 10 of the first embodiment, the antenna apparatus 20 of the second embodiment may be used, for example, for a smart meter.

As described above, compared with the antenna apparatus 10 of the first embodiment, the antenna apparatus 20 of the second embodiment including plural slots 22C, whose longitudinal direction is orthogonal to the longitudinal direction of the dipole antenna 11A, makes it possible to more flexibly adjust the directivity. Also, this configuration makes it possible to increase the gain of radio waves emitted from slots and to improve the antenna efficiency.

Accordingly, the second embodiment makes it possible to emit radio waves in a desired direction, depending on the purpose, by adjusting the orientation and the number of the slots 22C.

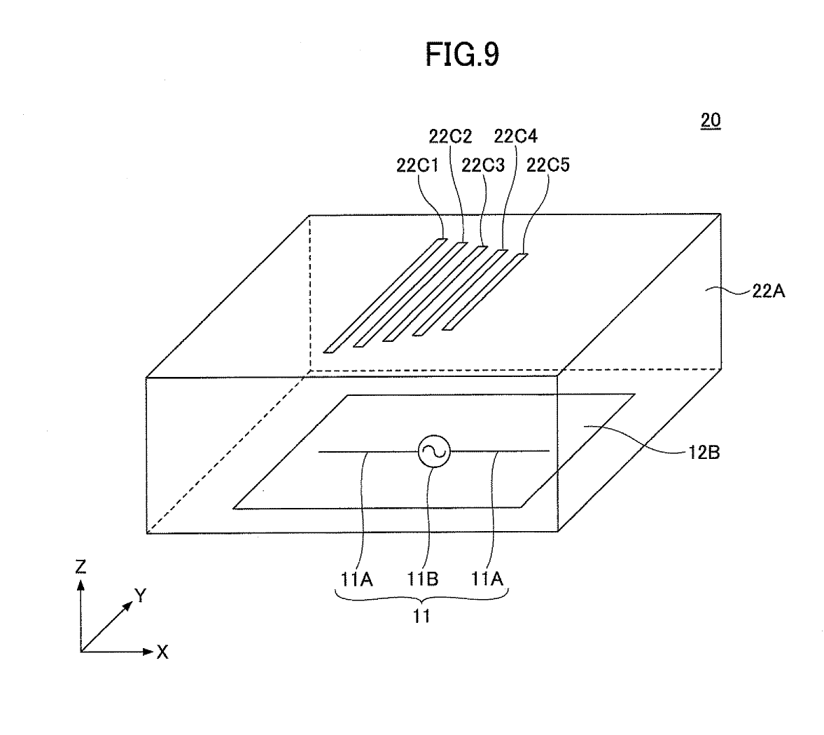

Next, an antenna apparatus 20A according to a variation of the second embodiment is described with reference to FIGS. 9 through 100.

FIG. 9 is a drawing illustrating the antenna apparatus 20A according to a variation of the second embodiment.

The antenna apparatus 20A is different from the antenna apparatus 20 of FIG. 7 in that slots 22C1 through 22C5 formed in the upper surface of the housing 22A have different lengths. Other components of the antenna apparatus 20A are substantially the same as those of the antenna apparatus 20. In FIG. 9, for illustration purposes, the dipole antenna 11A, the feeder 11B, and the substrate 12B are seen through the housing 22A.

Among the slots 22C1 through 22C5, the slot 22C1 is the longest and the slot 22C5 is the shortest.

For example, the length in the longitudinal direction of the slot 22C3 is one half (λ/2) of the wavelength (λ) of the operating frequency, the length in the longitudinal direction of the slot 22C1 is longer than one half (λ/2) of the wavelength (λ) of the operating frequency by 20%, the length in the longitudinal direction of the slot 22C2 is longer than one half (λ/2) of the wavelength (λ) of the operating frequency by 10%, the length in the longitudinal direction of the slot 22C4 is shorter than one half (λ/2) of the wavelength (λ) of the operating frequency by 10%, and the length in the longitudinal direction of the slot 22C5 is shorter than one half (λ/2) of the wavelength (λ) of the operating frequency by 20%.

In other words, the lengths in the longitudinal direction of the slots 22C1 through 22C5 are within a predetermined range (in this example, ±20%) around one half (λ/2) of the wavelength (λ) of the operating frequency, i.e., the length of the slot 22C3.

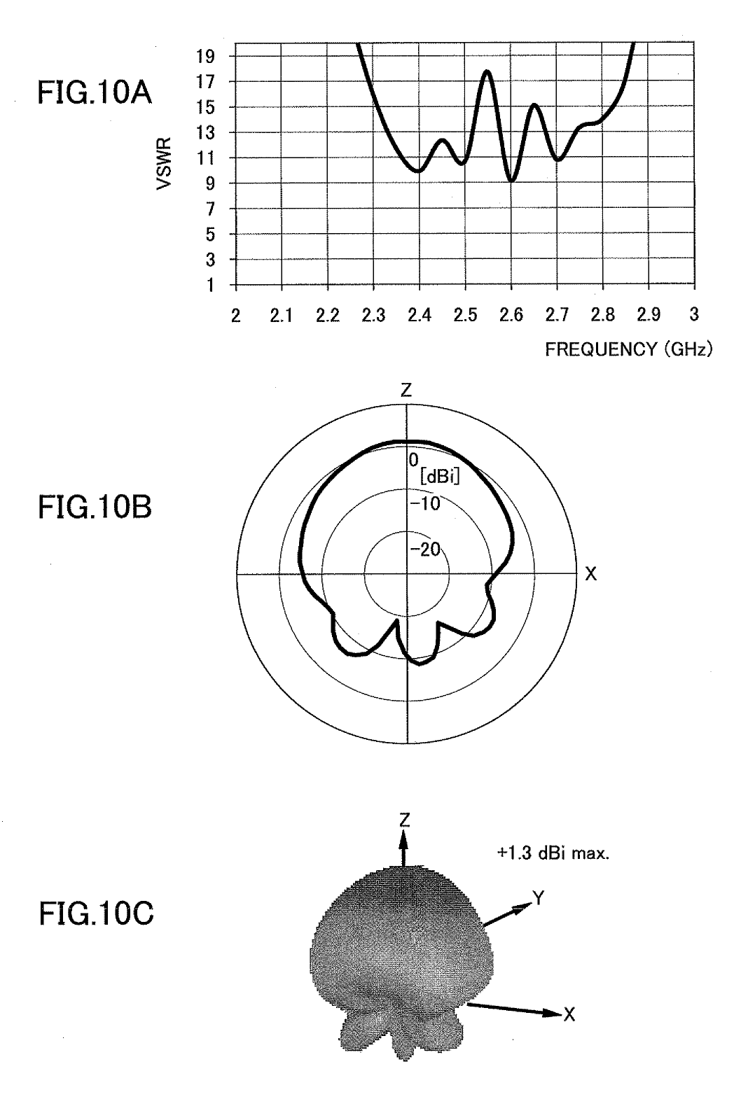

FIGS. 10A through 10C are drawings illustrating characteristics of the antenna apparatus 20A according to a variation of the second embodiment. FIG. 10A illustrates frequency characteristics of VSWR. FIG. 10B illustrates directivity on the XZ plane. FIG. 100 illustrates directivity represented by the sum of vertical polarization, horizontal polarization, and circular polarization. These antenna characteristics were obtained through a simulation where the operating frequency of the antenna apparatus 20A was set at 2.45 GHz.

As illustrated in FIG. 10A, the antenna apparatus 20A exhibits a low VSWR (about 10) at the operating frequency of 2.45 GHz and the lowest VSWR (about 9) at a frequency of 2.6 GHz.

The antenna apparatus 20A has wider VSWR characteristics compared with the antenna apparatus 10 of the first embodiment, and exhibits lower VSWRs in the high frequency range compared with the antenna apparatus 20 of the second embodiment.

As illustrated in FIG. 10B, the directivity of the antenna apparatus 20A in the +Z direction on the XZ plane is around 0 (dBi) and substantially uniform. This result indicates that radio waves are emitted in the +Z direction via the slots 22C1-22C5.

As illustrated in FIG. 100, the distribution of the directivity of the antenna apparatus 20A represented by the sum of vertical polarization, horizontal polarization, and circular polarization extends in the +Z direction, and is wider in the X-axis direction than in the Y-axis direction. The highest value of the directivity represented by the sum of vertical polarization, horizontal polarization, and circular polarization is +1.3 dBi.

Similarly to the antenna apparatus 10 of the first embodiment, the antenna apparatus 20A of the variation of the second embodiment may be used, for example, for a smart meter.

As described above, compared with the antenna apparatus 10 of the first embodiment, the antenna apparatus 20A of the variation of the second embodiment including plural slots 22C1 through 22C5, whose longitudinal direction is orthogonal to the longitudinal direction of the dipole antenna 11A, makes it possible to more flexibly adjust the directivity. Also, this configuration makes it possible to increase the gain of radio waves emitted from slots and to improve the antenna efficiency.

Accordingly, the variation of the second embodiment makes it possible to emit radio waves in a desired direction, depending on the purpose, by adjusting the lengths of the slots 22C1 through 22C5.

### Third Embodiment

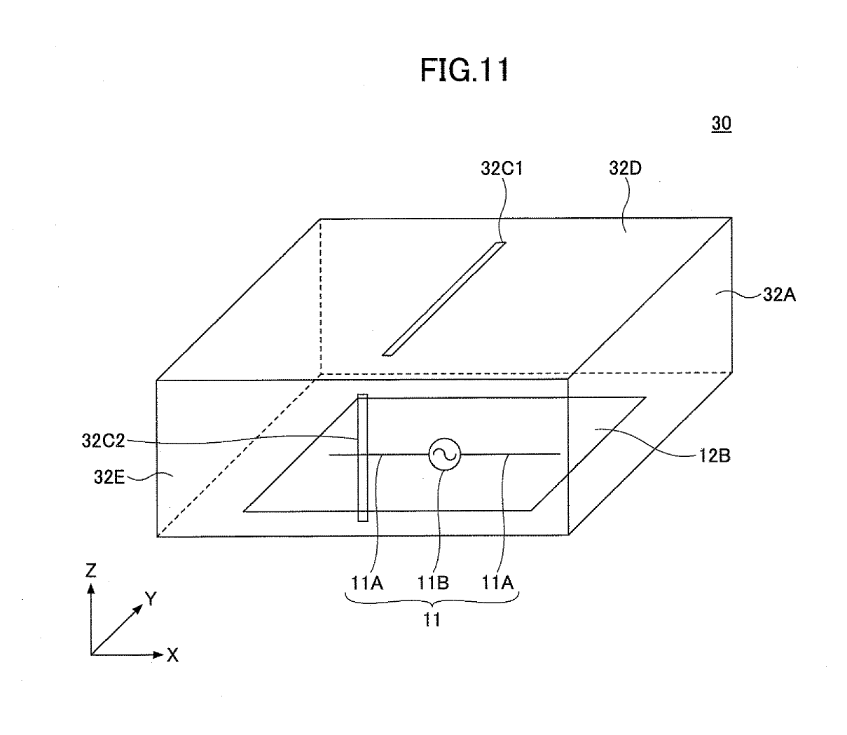

FIG. 11 is a drawing illustrating an antenna apparatus 30 of a third embodiment.

The antenna apparatus 30 of the third embodiment is different from the antenna apparatus of the first embodiment (see FIG. 4) in that slots 32C1 and 32C2 are formed in an upper surface (upper face or upper wall) 32D and a side surface (side face or side wall) 32E of a housing 32A. Other components of the antenna apparatus 30 are substantially the same as those of the antenna apparatus 10 of the first embodiment. Therefore, the same reference numbers are assigned to those components and their descriptions are omitted here. In FIG. 11, for illustration purposes, the dipole antenna 11A, the feeder 11B, and the substrate 12B are seen through the housing 32A.

The housing 32A may have a cuboid shape and may be made of a conductive material such as a metal. Preferably, the housing 32A include aluminum. The slots 32C1 and 32C2 are formed in the upper and side surfaces 32D and 32E of the housing 32A, respectively. The length in the longitudinal direction of each of the slots 32C1 and 32C2 is one half (λ/2) of the wavelength (λ) of the operating frequency of the antenna apparatus 30.

Similarly to the slot 12C of the antenna apparatus 10 of the first embodiment, the longitudinal direction (direction of the longer side) of the slot 32C1 is oriented along the Y axis, and the lateral direction (direction of the shorter side) of the slot 32C1 is oriented along the X axis. The longitudinal direction of the slot 32C1 is oriented at a predetermined angle with respect to the longitudinal direction of the dipole antenna 11A. In this example, the longitudinal direction (Y-axis direction) of the slot 32C1 is orthogonal to the longitudinal direction (X-axis direction) of the dipole antenna 11A.

The slot 32C2 is formed in the side surface 32E that is adjacent to the upper surface 32D, and is aligned with an imaginary line extending from the slot 32C1 along the upper surface 32D and the side surface 32E. The longitudinal direction (direction of the longer side) of the slot 32C2 is oriented along the Z axis, and the lateral direction (direction of the shorter side) of the slot 32C2 is oriented along the X axis. The longitudinal direction of the slot 32C2 is oriented at a predetermined angle with respect to the longitudinal direction of the dipole antenna 11A. In this example, the longitudinal direction (Z-axis direction) of the slot 32C2 is orthogonal to the longitudinal direction (X-axis direction) of the dipole antenna 11A.

As described in the first embodiment, the direction of an electric field formed by the dipole antenna 11A is oriented along the X axis, and the lateral direction of the slots 32C1 and 32C2 is oriented along the X axis.

Accordingly, an electric field is generated between a first side and a second side that face each other across the slot 32C1/32C2 in the lateral direction (X-axis direction). Therefore, the slots 32C1 and 32C2 provide substantially the same function as the dipole antenna 11A extending in the X-axis direction. Since the length in the longitudinal direction of the slots 32C1 and 32C2 is set at λ/2, the slots 32C1 and 32C2 resonate with radio waves emitted from the dipole antenna 11A and as a result, polarized electromagnetic radiation in the X-axis direction is emitted.

The antenna apparatus 30 of the third embodiment emits radio waves in the +Z direction and the −Y direction, respectively, from the slots 32C1 and 32C2.

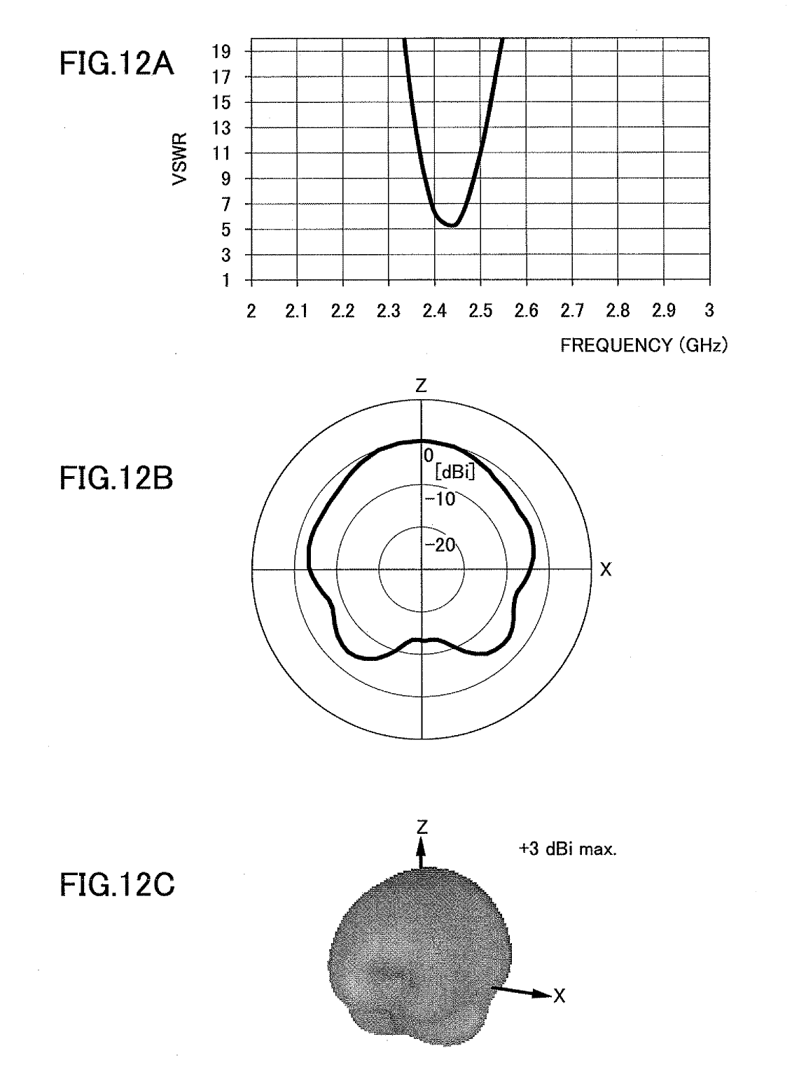

FIGS. 12A through 12C are drawings illustrating characteristics of the antenna apparatus 30 of the third embodiment. FIG. 12A illustrates frequency characteristics of VSWR. FIG. 12B illustrates directivity in the XZ plane. FIG. 12C illustrates directivity represented by the sum of vertical polarization, horizontal polarization, and circular polarization. These antenna characteristics were obtained through a simulation where the operating frequency of the antenna apparatus 30 was set at 2.45 GHz.

As illustrated in FIG. 12A, the antenna apparatus 30 exhibits the lowest VSWR (about 5) at the operating frequency of 2.45 GHz. Compared with the antenna apparatus 10 of the first embodiment, the antenna apparatus 30 has wider VSWR characteristics.

As illustrated in FIG. 12B, the directivity of the antenna apparatus 30 in the direction on the XZ plane is around 0 (dBi) and substantially uniform. This result indicates that radio waves are emitted in the +Z direction and the −Y direction via the slots 32C1 and 32C2, respectively.

As illustrated in FIG. 12C, the distribution of the directivity of the antenna apparatus 30 represented by the sum of vertical polarization, horizontal polarization, and circular polarization extends in the direction, and is wider in the X-axis direction than in the Y-axis direction. The highest value of the directivity represented by the sum of vertical polarization, horizontal polarization, and circular polarization is +3 dBi.

Thus, compared with the antenna apparatus 10 of the first embodiment, the antenna apparatus 30 of the third embodiment has improved VSWR characteristics and directivity characteristics.

Similarly to the antenna apparatus 10 of the first embodiment, the antenna apparatus 30 of the third embodiment may be used, for example, for a smart meter.

As described above, compared with the antenna apparatus 10 of the first embodiment, the antenna apparatus 30 of the third embodiment including the slots 32C1 and 32C2, whose longitudinal direction is orthogonal to the longitudinal direction of the dipole antenna 11A, makes it possible to more flexibly adjust the directivity. Also, this configuration makes it possible to increase the gain of radio waves emitted from slots and to improve the antenna efficiency.

Accordingly, the third embodiment makes it possible to emit radio waves in desired directions, depending on the purpose, by adjusting the orientation and the number of the slots 32C1 and 32C2.

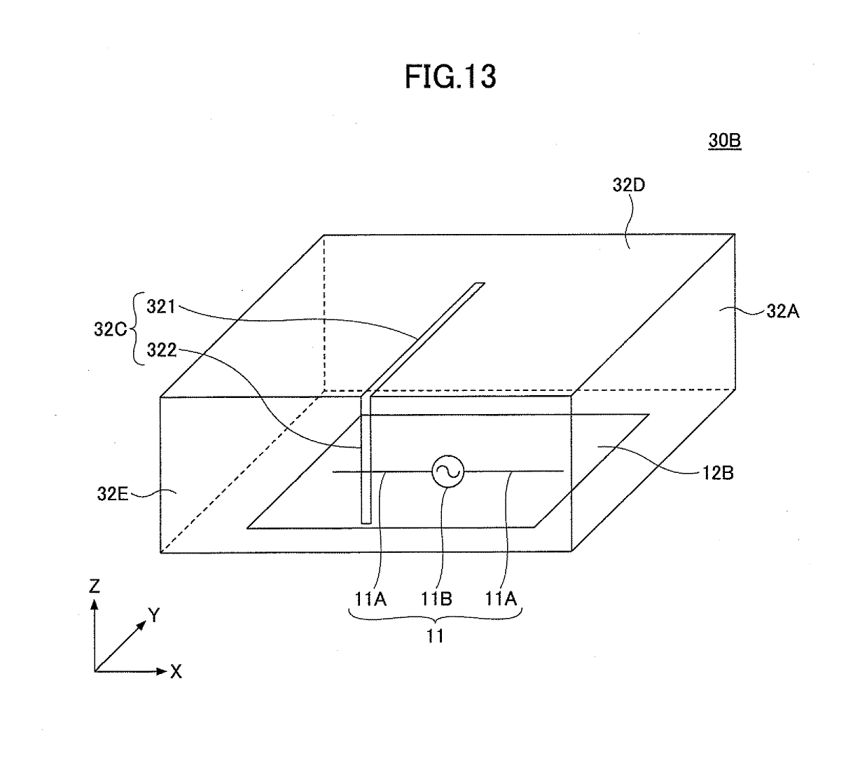

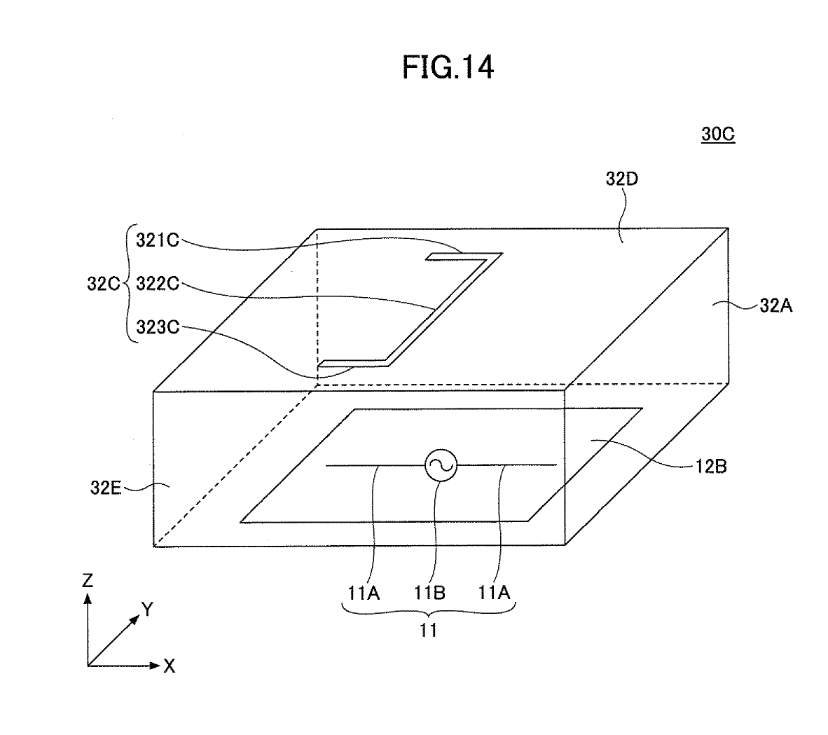

Variations of the antenna apparatus 30 of the third embodiment are described below with reference to FIGS. 13 and 14.

FIG. 13 is a drawing illustrating an antenna apparatus 30B according to a first variation of the third embodiment.

The antenna apparatus 30B may include a slot 32C that extends from the upper surface 32D to the side surface 32E of the housing 32A. The slot 32C may include a first part 321 and a second part 322. Other components of the antenna apparatus 30B are substantially the same as those the antenna apparatus 30. In FIG. 13, for illustration purposes, the dipole antenna 11A, the feeder 11B, and the substrate 12B are seen through the housing 32A.

The longitudinal direction of the first part 321 of the slot 32C formed in the upper surface 32D is oriented along the Y axis, and the lateral direction of the first part 321 is oriented along the X axis. The longitudinal direction of the first part 321 is oriented at a predetermined angle with respect to the longitudinal direction of the dipole antenna 11A. In this example, the longitudinal direction (Y-axis direction) of the first part 321 is orthogonal to the longitudinal direction (X-axis direction) of the dipole antenna 11A.

The longitudinal direction of the second part 322 of the slot 32C formed in the side surface 32E is oriented along the Z axis, and the lateral direction of the second part 322 is oriented along the X axis. The longitudinal direction of the second part 322 is oriented at a predetermined angle with respect to the longitudinal direction of the dipole antenna 11A. In this example, the longitudinal direction (Z-axis direction) of the second part 322 is orthogonal to the longitudinal direction (X-axis direction) of the dipole antenna 11A.

The total length in the longitudinal direction of the slot 32C including the first and second parts 321 and 322 is one half (λ/2) of the wavelength (λ) of the operating frequency of the antenna apparatus 30B.

Compared with the antenna apparatus 10 of the first embodiment, the antenna apparatus 303 of the first variation of the third embodiment has improved VSWR characteristics and directivity characteristics.

FIG. 14 is a drawing illustrating an antenna apparatus 30C according to a second variation of the third embodiment.

The antenna apparatus 30C may include a slot 32C formed in the upper surface 32D of the housing 32A.

The slot 32C may have a square-bracket shape and include first through third parts 321C, 322C, and 323C. In FIG. 14, for illustration purposes, the dipole antenna 11A, the feeder 113, and the substrate 12B are seen through the housing 32A.

The first and third parts 321C and 323C extend from the corresponding ends of the second part 322C. The longitudinal direction of the first and third parts 321C and 3230 is oriented along the X axis, and the lateral direction of the first and third parts 321C and 323C is oriented along the Y axis.

The second part 322C is located between the first and third parts 321C and 323C. The longitudinal direction of the second part 322C is oriented along the Y axis, and the lateral direction of the second part 322C is oriented along the X axis.

The total length of the slot 32C including the first through third parts 321C through 323C is one half (λ/2) of the wavelength (λ) of the operating frequency of the antenna apparatus 30C.

An electric field is generated at least between a first side and a second side that face each other across the second part 322C in the lateral direction (X-axis direction). Accordingly, the slot 32C provides substantially the same function as the dipole antenna 11A extending in the X-axis direction. Since the length in the longitudinal direction of the slot 32C is set at λ/2, the slot 32C resonates with radio waves emitted from the dipole antenna 11A and as a result, polarized electromagnetic radiation in the X-axis direction is emitted.

The slot 32C with a square-bracket shape is particularly preferable when the area of the upper surface 32D of the housing 32A is small.

Compared with the antenna apparatus 10 of the first embodiment, the antenna apparatus 30C of the second variation of the third embodiment has improved VSWR characteristics and directivity characteristics.

### Third Comparative Example

Before describing an antenna apparatus of a fourth embodiment, an antenna apparatus of a third comparative example is described.

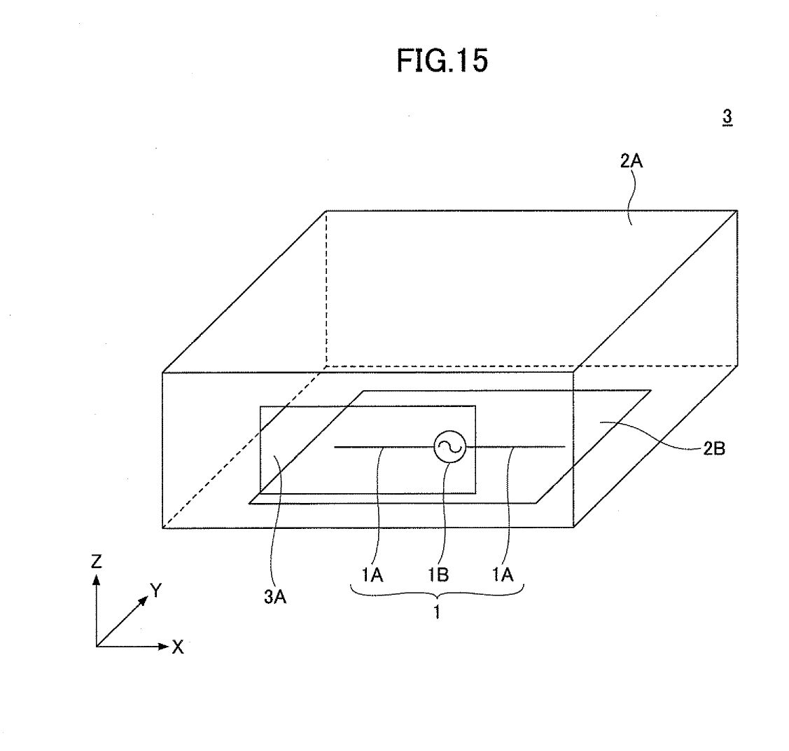

FIG. 15 is a drawing illustrating an antenna apparatus 3 of the third comparative example.

The antenna apparatus 3 of the third comparative example is different from the antenna apparatus 2 of the second comparative example (see FIG. 3) in that an opening 3A is formed in a +Y side surface (the front surface in FIG. 15) of the housing 2A. Other components of the antenna apparatus 3 are substantially the same as those of the antenna apparatus 2. In FIG. 15, for illustration purposes, the dipole antenna 1A, the feeder 1B, and the substrate 2B are seen through the housing 2A.

Since the opening 3A is formed in the housing 2A of the antenna apparatus 3, radio waves emitted from the dipole antenna 1A exit the housing 2A via the opening 3A.

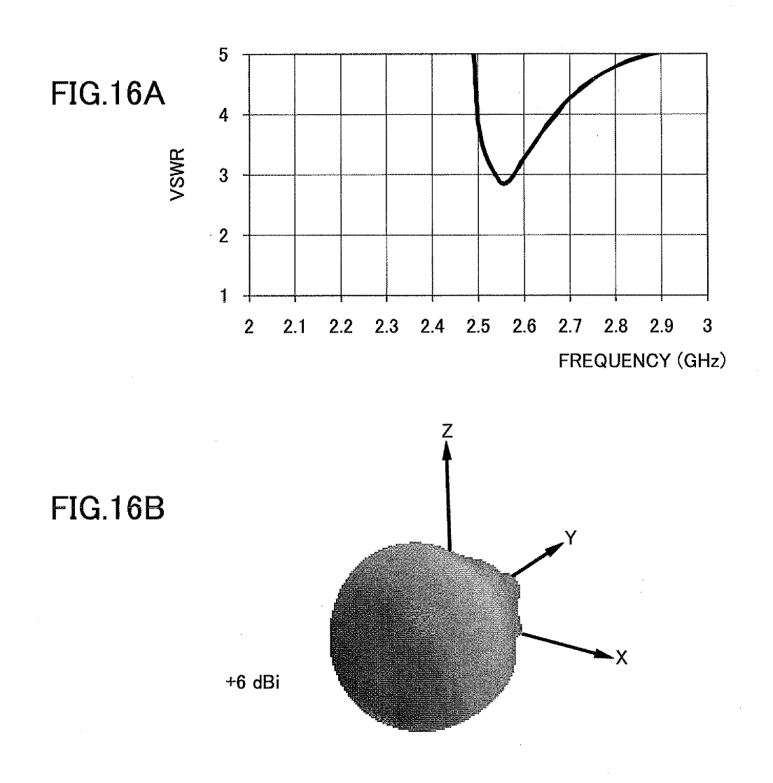

FIGS. 16A and 16B are drawings illustrating characteristics of the antenna apparatus 3 of the third comparative example. FIG. 16A illustrates frequency characteristics of VSWR. FIG. 16B illustrates directivity represented by the sum of vertical polarization, horizontal polarization, and circular polarization. These antenna characteristics were obtained through a simulation where the operating frequency of the antenna apparatus 3 was set at 2.45 GHz.

As illustrated in FIG. 16A, the antenna apparatus 3 exhibits the lowest VSWR (about 2.8) at a frequency of 2.56 GHz.

As illustrated in FIG. 16B, the distribution of the directivity of the antenna apparatus 3 represented by the sum of vertical polarization, horizontal polarization, and circular polarization is biased toward the −Y direction. It is assumed that this bias is caused by the opening 3A formed in the −Y side surface of the housing 2A. The highest value of the directivity represented by the sum of vertical polarization, horizontal polarization, and circular polarization is +6 dBi.

### Fourth Embodiment

Next, an antenna apparatus 40 according to a fourth embodiment is described.

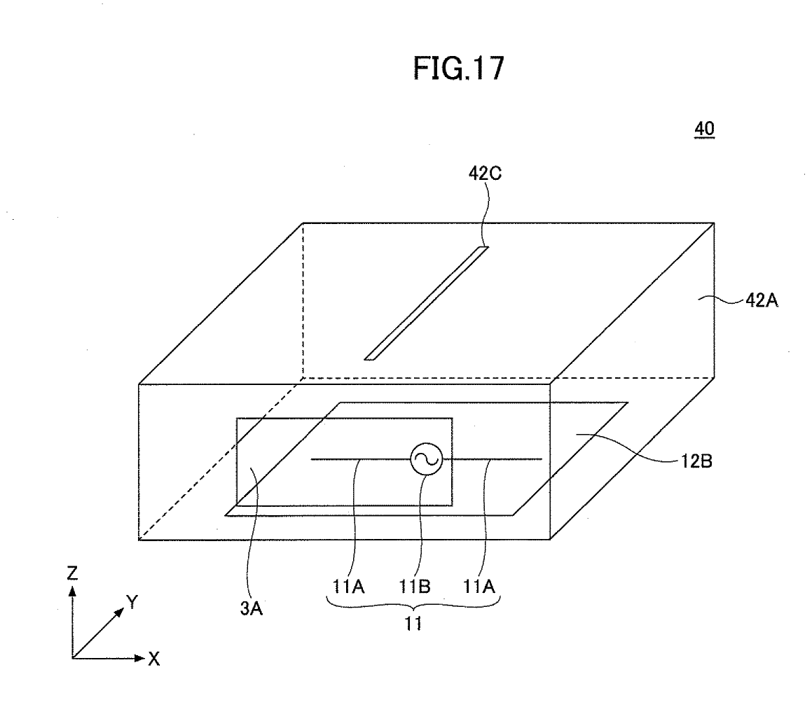

FIG. 17 is a drawing illustrating the antenna apparatus 40 of the fourth embodiment.

The antenna apparatus 40 of the fourth embodiment is a combination of the antenna apparatus of the first embodiment (see FIG. 4) and the antenna apparatus 3 of the third comparative example. A slot 42C, which is substantially the same as the slot 12C of the antenna apparatus 10, is formed in the upper surface of a housing 42A of the antenna apparatus 40.

Other components of the antenna apparatus are substantially the same as those of the antenna apparatus 10 and the antenna apparatus 3. Therefore, the same reference numbers are assigned to those components and their descriptions are omitted here. In FIG. 17, for illustration purposes, the dipole antenna 11A, the feeder 11B, and the substrate 12B are seen through the housing 42A.

The longitudinal direction (direction of the longer side) of the slot 42C is oriented along the Y axis, and the lateral direction (direction of the shorter side) of the slot 42C is oriented along the X axis. The longitudinal direction of the slot 42C is oriented at a predetermined angle with respect to the longitudinal direction of the dipole antenna 11A. In this example, the longitudinal direction (Y-axis direction) of the slot 42C is orthogonal to the longitudinal direction (X-axis direction) of the dipole antenna 11A.

The length in the longitudinal direction of the slot 42C is one half (λ/2) of the wavelength (λ) of the operating frequency of the antenna apparatus 40.

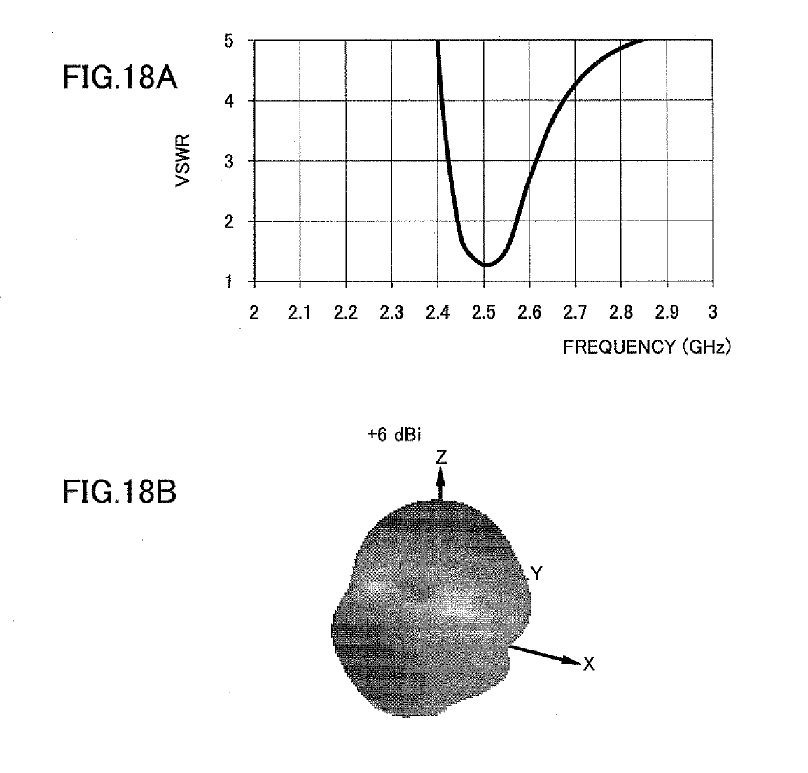

FIGS. 18A and 18B are drawings illustrating characteristics of the antenna apparatus 40 of the fourth embodiment. FIG. 18A illustrates frequency characteristics of VSWR. FIG. 18B illustrates directivity represented by the sum of vertical polarization, horizontal polarization, and circular polarization. These antenna characteristics were obtained through a simulation where the operating frequency of the antenna apparatus 40 was set at 2.45 GHz.

As illustrated in FIG. 18A, the antenna apparatus 40 exhibits the lowest VSWR (about 1.3) at a frequency of 2.5 GHz near the operating frequency of 2.45 GHz. Compared with the antenna apparatus 3 of the third comparative example, the antenna apparatus 40 has wider VSWR characteristics.

As illustrated in FIG. 18B, compared with the antenna apparatus 3 of the third comparative example, the distribution of the directivity of the antenna apparatus 40 represented by the sum of vertical polarization, horizontal polarization, and circular polarization is shifted in the +Z direction. This result indicates that radio waves are emitted in the direction via the slot 42C formed in the upper surface of the housing 42A. The highest value of the directivity represented by the sum of vertical polarization, horizontal polarization, and circular polarization is +6 dBi.

As described above, compared with the antenna apparatus 10 of the first embodiment, the antenna apparatus 40 of the fourth embodiment including the opening 3A and the slot 42C, whose longitudinal direction is orthogonal to the longitudinal direction of the dipole antenna 11A, makes it possible to more flexibly adjust the directivity. Also, this configuration makes it possible to increase the gain of radio waves emitted from slots and to improve the antenna efficiency.

Accordingly, the fourth embodiment makes it possible to emit radio waves in a desired direction, depending on the purpose, by adjusting the orientation and the number of the slot 42C.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. An antenna apparatus, comprising:
a housing made of a conductive material and having a slot formed in a first surface thereof; and
an antenna disposed in the housing,
wherein a longitudinal direction of the slot is oriented at a predetermined angle with respect to a longitudinal direction of the antenna.

2. The antenna apparatus as claimed in claim 1, wherein the predetermined angle is 90 degrees.

3. The antenna apparatus as claimed in claim 1, wherein the housing has a cuboid shape and has another slot formed in a second surface thereof, the second surface being different from the first surface.

4. The antenna apparatus as claimed in claim wherein
the housing has a cuboid shape; and
the slot extends from the first surface to a second surface of the housing, the second surface being adjacent to the first surface.

5. The antenna apparatus as claimed in claim 1, wherein
the housing has a cuboid shape; and
a plurality of the slots are formed in the first surface.

6. The antenna apparatus as claimed in claim 5, wherein
the slots have different lengths; and
the lengths of the slots are within a predetermined range around one half of a wavelength of a frequency used by the antenna apparatus.

7. The antenna apparatus as claimed in claim 1, wherein an opening other than the slot is further formed in a surface of the housing.

8. The antenna apparatus as claimed in claim 1, further comprising:
a cover made of an insulator and configured to cover the slot.

9. The antenna apparatus as claimed in claim 1, further comprising:
a substrate disposed in the housing,
wherein the antenna is disposed on the substrate.

10. The antenna apparatus as claimed in claim 1, wherein the slot has a square-bracket shape.
